(19) United States
(12) Patent Application Publication
(10) Pub. No.: US 2008/0245193 A1
(43) Pub. Date: Oct. 9, 2008

(54) Wrench Device

(76) Inventor: Michael L. Lipka, Riverview, FL (US)

Correspondence Address: HARSHAW RESEARCH, INC., 210 W. TECUMSEH STREET, OTTAWA, KS, 66067, US

(21) Appl. No.: 11/697,152

(22) Filed: Apr. 5, 2007

(51) Int. Cl. B25B 13/00

(52) U.S. Cl. 81/58.2

(57) ABSTRACT

A wrench device includes an input gear configured to receive an input member such as a ratchet handle. The wrench device includes a socket housing defining a receiving area and an open side. A plurality of intermediary gears operatively couple the input gear to the socket housing. The wrench device may include a set of inserts, each being respectively receivable in the socket housing receiving area, defining a receiving area, and having an open side adjacent the socket housing open side when received in the socket housing receiving area. Each insert includes a cavity complementary to a spring biased lock coupled to an interior wall of the socket housing such that the insert is held in the socket housing receiving area but may be removed therefrom when sufficient is applied to the insert.

### BACKGROUND OF THE INVENTION

This invention relates generally to tools for turning fasteners and the like and, more particularly, to a wrench device that enables a user to secure the head of a fastener with a socket head and then have the benefit of a ratchet mechanism to tighten or loosen the hard to reach fastener.

There are many times and situations when a mechanic has difficulty tightening or loosening a bolt or nut in that the fastener is in a difficult to reach location. For example, the head of the bolt may be closely surrounded by other parts of an engine, resulting in having to remove those other parts merely to tighten a single bolt. Grasping and turning difficult to reach line fittings is especially difficult.

Various devices have been proposed in the art for easing the difficult of getting a wrench head on line fittings or other difficult to reach fasteners. Namely, wrench heads having a side opening and offset ratchet mechanism have somewhat eased the burdens described above. Although assumably effective for their intended purposes, the existing devices are not configured to fit many different sizes and configurations of fittings.

Therefore, it would be desirable to have a wrench device that may be easily and quickly secured about the head of a fastener or line fitting in difficult to reach locations. Further, it would be desirable for such a wrench device to have a ratchet mechanism so as to avoid having to repeatedly have to reposition and reattach the wrench head to the fastener or fitting. In addition, it would be desirable to have a wrench device that is quickly adaptable to fit many different sizes and configurations of fasteners or fittings.

### SUMMARY OF THE INVENTION

Accordingly, a wrench device according to the present invention includes an input gear configured to receive an input member such as a ratchet extension or handle. The wrench device also includes a socket housing defining a receiving area and having an open side. A plurality of intermediary gears operatively couple the input gear to the socket housing and such that the input gear is operatively coupled to the socket housing at all times by at least one intermediary gear. The input gear, socket housing, and plurality of intermediary gears may be positioned within a casing. The wrench device may include a set of inserts, each insert being respectively receivable in the socket housing receiving area, defining a receiving area, and having an open side adjacent the socket housing open side when received in the socket housing receiving area. Each insert receiving area presents a configuration different from each other insert receiving area.

At least one interior wall of the socket housing may define a cavity extending away from the socket housing receiving area. A spring biased lock may be coupled to the socket housing such that the lock is partially outside the socket housing cavity when at a first configuration and such that the lock is entirely inside the socket housing cavity when at a second configuration. The lock is biased toward the first configuration. Each respective insert defines a cavity adjacent the socket housing cavity when the insert is received in the socket housing receiving area. The insert cavity has a configuration complementary to a configuration of the lock such that the lock is partially inside the insert cavity when the insert is received in the socket housing receiving area and the lock is at the first configuration.

Therefore, a general object of this invention is to provide a wrench device for securing and turning difficult to access nuts, bolts, or line fittings.

Another object of this invention is to provide a wrench device, as aforesaid, having a ratchet mechanism.

Still another object of this invention is to provide a wrench device, as aforesaid, having a socket housing defining an open side for convenient attachment to fasteners and line fittings.

Yet another object of this invention is to provide a wrench device, as aforesaid, having one or more inserts for the socket housing such that the wrench device may be coupled to fasteners of various sizes and configurations.

A further object of this invention is to provide a wrench device, as aforesaid, that is convenient to use and economical to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a wrench device according to a preferred embodiment of the present invention;

FIG. 2 is an exploded view of the wrench device as in FIG. 1;

FIG. 3a is a side view of the wrench device as in FIG. 1;

FIG. 3b is a sectional view taken along line 3b-3b of FIG. 3a;

FIG. 4a is an isolated view on an enlarged scale taken from FIG. 3b; and

FIG. 4b is another isolated view on an enlarged scale taken from FIG. 3b.

### DESCRIPTION OF THE PREFERRED EMBODIMENT

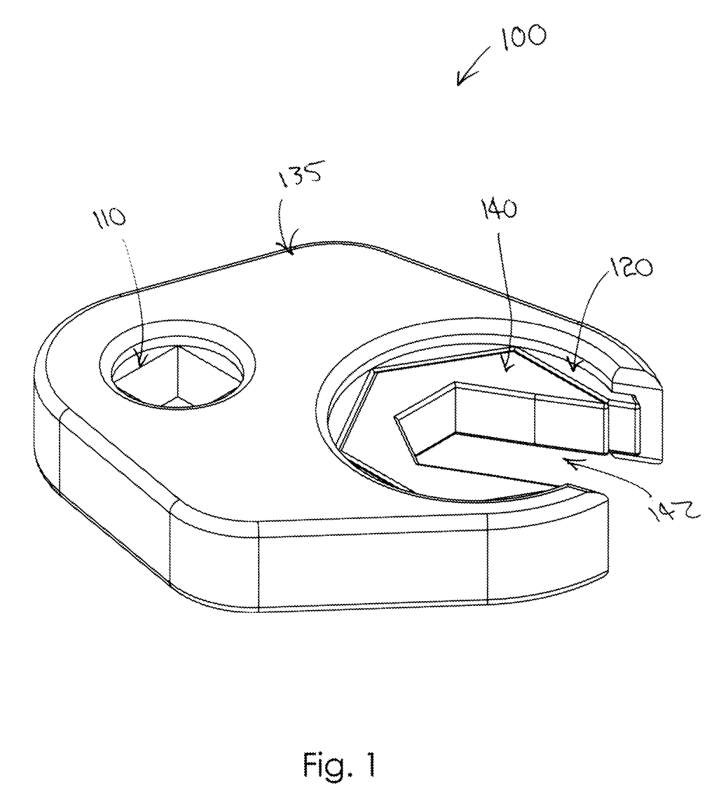

A wrench device 100 according to the present invention will now be described in detail with reference to FIGS. 1 through 4b of the accompanying drawings. More particularly, a wrench device 100 according to the current invention includes an input gear 110, a socket housing 120, at least one intermediary gear 130, and an insert 140.

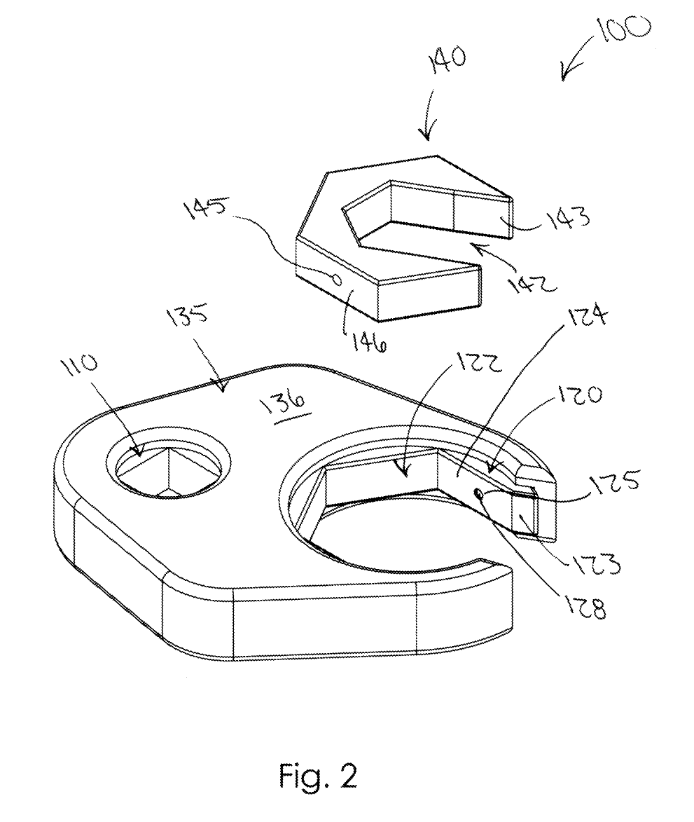

The input gear 110 may be configured (as in FIG. 1) to receive an input member such as a ratchet extension or a handle (not shown). The socket housing 120 defines a receiving area 122 and may have an open side 123 (FIG. 2). While the socket housing receiving area 122 shown throughout the drawings has a generally hexagonal configuration (or in other words, a configuration complementary to a hexagonal member such as a hex bolt head,) other configurations may also be appropriate. As shown in FIG. 2, the socket housing 120 may have at least one interior wall 124 that defines the receiving area 122.

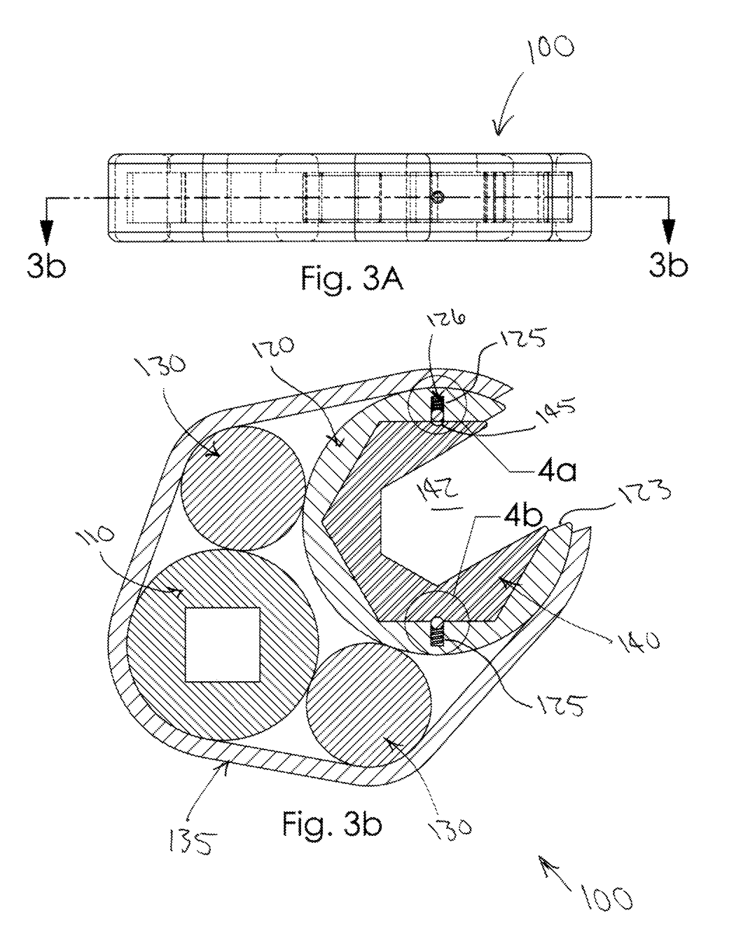

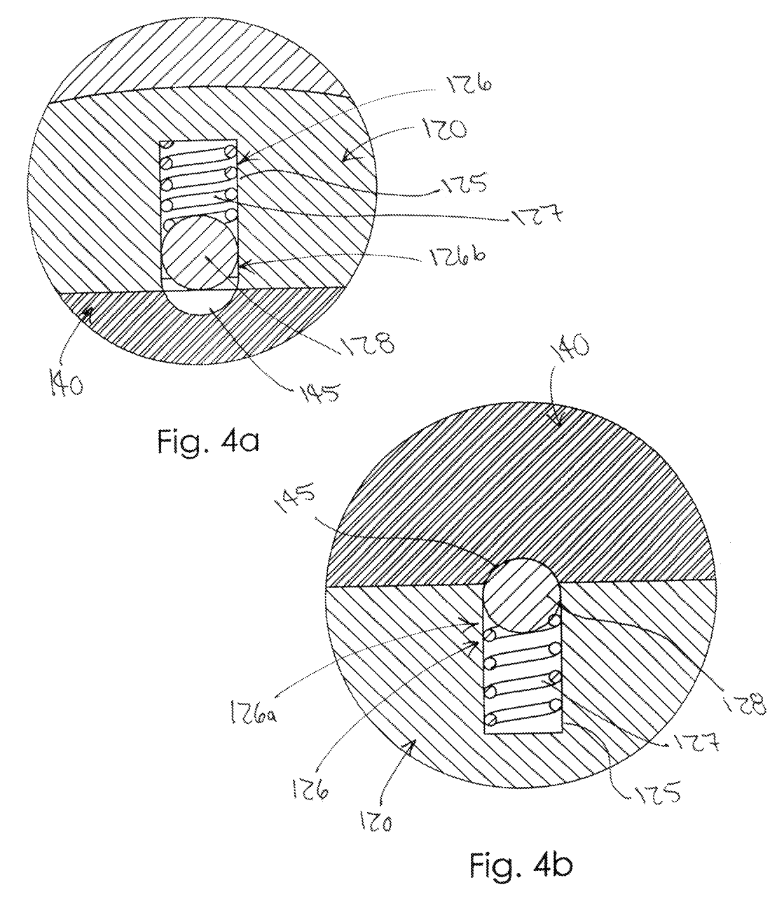

At least one of the socket housing interior walls 124 may define a cavity 125 that extends away from the socket housing receiving area 122. While FIG. 3b shows opposed interior walls 124 defining respective cavities 125, it should be appreciated that more or fewer interior walls 124 may define respective cavities 125 and that one wall 124 may define one or more respective cavity 125. At least one spring biased lock 126 may be coupled to the socket housing 120 such that a respective lock 126 is partially outside each socket housing cavity 125 when at a first configuration 126a (FIG. 4b) and such that a respective lock 126 is entirely inside each socket housing cavity 125 when at a second configuration 126b (FIG. 4a). Each lock 126 may be biased toward the first configuration 126a and may include a spring 127 and a rounded or angled contact member 128. The contact members 128 shown throughout the drawings are generally spherical, although other configurations would also work. As shown in FIG. 4b, the contact member 128 may be partially outside the socket housing cavity 125 when the lock 126 is at the first configuration 126a, and as shown in FIG. 4a, the contact member 128 may be entirely inside the socket housing cavity 125 when the lock 126 is at the second configuration 126b. Interaction with an insert 140 may cause the lock(s) 126 to move from the first configuration 126a to the second configuration 126b, as is discussed in detail below.

FIG. 3b shows two intermediary gears 130 operatively coupling the input gear 110 to the socket housing 120, though more or fewer intermediary gears 130 may be used. The input gear 110 is operatively coupled to the socket housing 120 at all times by at least one respective intermediary gear 130. Two intermediary gears 130 are used in the wrench device 100 shown in FIG. 3b so that while one of the intermediary gears 130 is at the socket housing open side 123, the other intermediary gear 130 remains in contact with the socket housing 120. A casing 135 may contain the input gear 110, the socket housing 120, and the intermediary gear(s) 130. As shown in FIG. 2, the casing 135 may have a side face 136, and the socket housing receiving area 122 may be entirely accessible at the side face 136.

As shown in FIGS. 1 and 3b, the insert 140 is receivable in the socket housing receiving area 122 and defines a receiving area 142. The insert 140 may have an open side 143 that is adjacent the housing open side 123 when the insert 140 is received in the socket housing receiving area 122. As shown in FIGS. 2 and 3b, the insert 140 may have a cavity 145 that is adjacent each socket housing cavity 125 when the insert 140 is received in the socket housing receiving area 122. A face 146 of the insert 140 may define the cavity 145 (FIG. 2). Each insert cavity 145 may have a configuration that is complementary to a configuration of a respective lock 126 such that the lock 126 is partially inside the insert cavity 145 when the insert 140 is received in the socket housing receiving area 122 and the lock 126 is at the first configuration 126a (FIG. 4b). When the lock 126 is partially inside the insert cavity 145 (FIG. 4b), the lock 126 may apply a force to the insert 140 to resist removal of the insert 140 from the socket housing receiving area 122. The insert 140 may be rigid and may be constructed of metal or any other appropriate material. While the insert receiving area 142 shown throughout the drawings has a generally hexagonal configuration (or in other words, a configuration complementary to a hexagonal member such as a hex bolt head,) other configurations may also be appropriate.

A set of the inserts 140 may be provided to increase the functionality of the wrench device 100. Each insert 140 may be respectively receivable in the socket housing receiving area 122 and have a configuration as described above. Each insert 140 may have a unique receiving area 142 (i.e., a receiving area 142 that is different from each other insert receiving area 142) so that each insert 140 has a unique functionality. For example, one respective insert 140 may have a generally hexagonal configuration of a first size, another respective insert 140 may have a generally hexagonal configuration of another size, yet another respective insert 140 may have a rectangular configuration, etc.

In use, the insert 140 may be received in the socket housing receiving area 122. If a set of inserts 140 is provided, the insert 140 having the desired functionality (i.e., the desired receiving area configuration) may be selected and then received in the socket housing receiving area 122. Before the insert 140 is received in the socket housing receiving area 122, the lock 126 may be at the first configuration 126a. Contact between a respective insert face 146 and the lock 126 (e.g., the rounded contact member 128) may urge the spring 127 to compress and the lock 126 to move to from the first configuration 126a to the second configuration 126b. Once the insert cavity 145 is adjacent the lock 126, the spring 127 may return the lock 126 to the first configuration 126a, placing a part of the contact member 128 in the insert cavity 145 (FIG. 4b). As noted above, when the lock 126 is partially inside the insert cavity 145 (FIG. 4b), the lock 126 may apply a force to the insert 140 to resist removal of the insert 140 from the socket housing receiving area 122.

Once the insert 140 is in the socket housing receiving area 122, the input gear 110 may be turned (such as by a ratchet extension), causing the intermediary gear(s) 130 to rotate the socket housing 120 as discussed above. The insert 140 may rotate with the socket housing 120. An item such as a bolt head or other fastener may be placed in the insert receiving area 142 so that rotation of the insert 140 causes the item to rotate.

To remove the insert 140 from the socket housing receiving area 122, a user may apply sufficient force to overcome the resistance of the lock 126, causing contact between a respective insert face 146 and the lock 126 to again urge the spring 127 to compress and the lock 126 to move from the first configuration 126a to the second configuration 126b.

It is understood that while certain forms of this invention have been illustrated and described, it is not limited thereto except insofar as such limitations are included in the following claims and allowable functional equivalents thereof.

1-16. (canceled)

17. A wrench device for use in rotating a fastener situated between closely situated objects, comprising:
an input gear;
a socket housing defining a receiving area;
a pair of intermediary gears directly coupled to said socket housing and to said input gear so as to operatively coupling said input gear to said socket housing;
a casing containing said input gear, said socket housing, and said at least one intermediary gear;
a set of inserts respectively receivable in said socket housing receiving area, each said insert defining a receiving area, each insert receiving area having a configuration different from each other insert receiving area;
wherein said casing has a side face and said socket housing receiving area is entirely accessible at said side face;
wherein said input gear and said pair of intermediary gears are situated in immediate proximity to said socket housing such that said casing includes a configuration positionable between closely situated obstacles such that a selective insert receiving area is positionable to engage and rotate a fastener there situated;
wherein:
said socket housing has at least one interior wall defining said socket housing receiving area, said at least one interior wall having a generally planar configuration;
at least one said interior wall defines a cavity extending away from said socket housing receiving area;
a spring biased lock is coupled to said socket housing such that said lock is partially outside said socket housing cavity when at a first configuration and such that said lock is entirely inside said socket housing cavity when at a second configuration, said lock being biased toward said first configuration;
each respective insert has a cavity adjacent said socket housing cavity when said insert is received in said socket housing receiving area, said insert cavity having a configuration complementary to a configuration of said lock such that said lock is partially inside said insert cavity when said insert is received in said socket housing receiving area and said lock is at said first configuration;
said spring biased lock includes a spring and a rounded contact member;
said rounded contact member is partially outside said socket housing cavity when said lock is at said first configuration; and
said rounded contact member is entirely inside said socket housing cavity when said lock is at said second configuration.

18. (canceled)

19. (canceled)

20. The wrench device as in claim 17, wherein:
each respective insert has a face defining said insert cavity;
contact between a respective insert face and said rounded contact member urges said spring to compress and said lock to move from said first configuration to said second configuration;
at least one said insert is constructed of metal; and
said socket housing receiving area has a generally hexagonal configuration.
